(19) United States
(12) Patent Application Publication
(10) Pub. No.: US 2024/0288110 A1
(43) Pub. Date: Aug. 29, 2024

(54) PORTABLE FLUID SPRAYER HAVING A TUBE DAMPENER

(71) Applicant: Graco Minnesota Inc., Minneapolis, MN (US)

(72) Inventors: Robert W. Kinne, Columbia Heights, MN (US); Diane L. Olson, Elk River, MN (US); Andrew J. Ericson, Andover, MN (US); Christopher C. Hines, Andover, MN (US)

(21) Appl. No.: 18/564,930

(22) PCT Filed: May 19, 2022
(86) PCT No.: PCT/US22/30067

§ 371 Date: Nov. 28, 2023

Related U.S. Application Data
(60) Provisional application No. 63/195,694, filed on Jun. 1, 2021.

(51) Int. Cl. F16L 55/04; B05B 7/24; F16L 7/00

(52) U.S. Cl. CPC F16L 55/041; B05B 7/2443; F16L 7/00

(57) ABSTRACT

A tube dampener (12) for a fluid sprayer (10) is disposed downstream of the pump (18) to receive spray fluid output by the pump. The tube dampener includes a rigid body (24) and a flexible tube (26) disposed within the rigid body. The flexible tube is resilient to smooth pressure fluctuations in the spray fluid output by the pump, providing consistent pressure at a spray nozzle (28) downstream of the tube dampener (12).

### CROSS-REFERENCE TO RELATED APPLICATION(S)

This application claims the benefit of U.S. Provisional Application No. 63/195,694 filed Jun. 1, 2021 and entitled “PORTABLE FLUID SPRAYER HAVING A TUBE DAMPENER,” the disclosure of which is hereby incorporated by reference in its entirety.

### BACKGROUND

This disclosure relates generally to airless fluid sprayers. More particularly, this disclosure relates to accumulators and pressure dampeners for airless fluid sprayers.

Airless fluid sprayers include a pump that draws spray liquid from a liquid source and drives that liquid downstream for application on a substrate. Such fluid sprayers can spray various fluids, such as paint, varnishes, lacquer, finishes, stains, rust inhibitors, epoxy coatings, and other coatings that dry into a finish on the substrate. Such sprayers can experience pressure fluctuations at the spray outlet due to the relative locations of the spray orifice and the pump outlet. Such pressure fluctuations can cause an uneven spray pattern.

### SUMMARY

According to one aspect of the disclosure, a tube dampener for use in a portable fluid sprayer includes a dampener body elongate along a flow axis and having an interior space; a flexible tube disposed within the interior space such that a gap is disposed circumferentially around the flexible tube and radially between the flexible tube and the dampener body, the flexible tube formed such that the flexible tube can flex in response to pressure pulsations of spray fluid flowing through the flexible tube; and a restriction disposed downstream of the flexible tube to inhibit free flow of the spray fluid out of the flexible tube.

According to an additional or alternative aspect of the disclosure, a portable fluid sprayer includes a sprayer body; a pump disposed within the sprayer body; a tube dampener disposed downstream from the pump and that receives spray fluid output from the pump; and a nozzle. The tube dampener includes a dampener body elongate along a flow axis, the dampener body defining an interior space; and a flexible tube disposed within the interior space, the flexible tube configured to dampen pulsation of the spray fluid output from the pump and traveling through the flexible tube. The nozzle is disposed downstream from the flexible tube, and the nozzle is configured to receive the spray fluid output from the flexible tube and generate a spray of the spray fluid.

### BRIEF DESCRIPTION OF THE DRAWINGS

FIG. 1 is a block diagram showing a fluid sprayer and tube dampener.

FIG. 2 is an isometric view of a fluid sprayer with a tube dampener.

FIG. 3A is a cross-sectional view taken along line 3-3 in FIG. 2.

FIG. 3B is an enlarged view of detail B in FIG. 3A.

### DETAILED DESCRIPTION

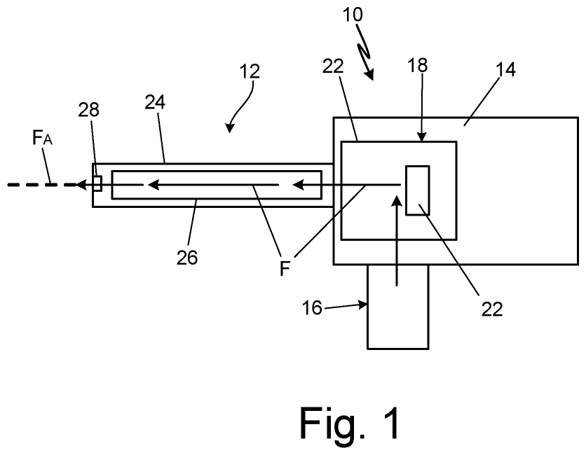

FIG. 1 is a block diagram of fluid sprayer 10 and tube dampener 12. Fluid sprayer 10 includes sprayer body 14, reservoir 16, and pump 18. Pump 18 includes pump body 20 and fluid displacer 22. Tube dampener 12 includes dampener body 24, flexible tube 26, and outlet restriction 28.

Sprayer 10 is configured to generate a spray of fluid for application on a substrate. For example, sprayer 10 can be used for applying paint, varnishes, lacquer, finishes, stains, rust inhibitors, epoxy coatings, sealants, waterproofing, and other coatings that dry into a finish on the substrate. Paint will generally be used herein as an example, but it is understood that sprayer 10 can apply other coatings that dry into a finish on the substrate.

Sprayer body 14 contains and can support other components of sprayer 10. Reservoir 16 is configured to store a supply of spray fluid. Pump 18 is fluidly connected to reservoir 16 to draw the spray fluid from reservoir 16 and pump the spray fluid downstream for spraying, as shown by flow arrows F. Pump body 20 is disposed at least partially within sprayer body 14. Fluid displacer 22 is disposed at least partially within pump body 20. Fluid displacer 22 is configured to reciprocate to pump the fluid from reservoir 16 and downstream through tube dampener 12. For example, fluid displacer 22 can be configured as one or more pistons or one or more diaphragms, among other options.

Tube dampener 12 is disposed downstream from pump 18. Tube dampener 12 receives the spray fluid output by pump 18 such that the spray fluid flows through tube dampener 12 prior to being emitted from sprayer 10 as the fluid spray. Specifically, the spray fluid flows within the flexible tube 26 of the tube dampener 12. In the example shown, tube dampener 12 is elongate along a flow axis FA. Tube dampener 12 extends straight along axis FA. Tube dampener 12 can be configured to dampen pressure pulsations during spraying at pressures of at least about 50 pounds per square inch (psi) (about 0.34 megapascal (MPa)). Tube dampener 12 can be configured to dampen pressure pulsations during spraying at pressures up to about 8,000 psi (about 55.16 MPa).

Dampener body 24 extends away from sprayer body 14. Dampener body 24 can, in some examples, be directly connected to sprayer body 14 to be directly supported by sprayer body 14. In some examples, dampener body 24 is connected to another component of sprayer 10, such as pump body 20 or another component, to be indirectly supported by sprayer body 14. Dampener body 24 is formed separately from pump body 20. Dampener body 24 can be cylindrical, among other options.

Dampener body 24 is a rigid housing. In the example shown, dampener body 24 is cantilevered relative to sprayer body 14. Flexible tube 26 is disposed within dampener body 24. Dampener body 24 and flexible tube 26 are disposed coaxially on flow axis FA. Flexible tube 26 is not disposed within and does not extend into the pump body 20. Flexible tube 26 conveys the spray fluid through at least a portion of the length of the dampener body 24. Flexible tube 26 is fully disposed within dampener body 24 and does not project outside of dampener body 24 in the example shown.

Flexible tube 26 is configured to expand and retract in response or pressure fluctuations in the spray fluid output by pump 18, thereby smoothing the fluctuations and providing a consistent spray pressure downstream of flexible tube 26. As discussed in more detail below, flexible tube 26 is spaced from dampener body 24 to form a gap around flexible tube 26 and within dampener body 24. The gap is formed such that flexible tube 26 can expand within dampener body 24 in response to the pressure fluctuations. The gap is coaxial with flexible tube 26 and dampener body 24 and disposed radially therebetween relative to the flow axis FA.

Restriction 28 is disposed downstream from flexible tube 26. Restriction 28 is disposed at or downstream from a downstream end of flexible tube 26. Restriction 28 is configured to inhibit flow of the spray material downstream out of tube dampener 12 while pump 18 is not pumping. In some examples, an area of the flowpath through restriction 28 is smaller than an area of the flowpath through flexible tube 26 taken orthogonal to the flow axis FA through flexible tube 26. In some examples, restriction 28 is formed as a constrictive orifice that inhibits flow downstream out of tube dampener 12 due to the small size of the constrictive orifice. In some examples, restriction 28 is formed as a valve configured to control flow downstream out of tube dampener 12. For example, restriction 28 can be a pressure-actuated valve that opens in response to a fluid pressure at the valve, restriction 28 can be a manually-actuated valve that is actuated between open and closed states by the user, or restriction 28 can be formed as any other type of valve suitable for controlling flow of the spray fluid. Restriction 28 can thus be of any desired configuration suitable for preventing the spray fluid from freely flowing downstream out of tube dampener 12.

Restriction 28 prevents the spray fluid from freely flowing out of flexible tube 26 when pump 18 is not actively pumping. Restriction 28 facilitates flexible tube 26 acting as a pressure accumulator to provide quick responsiveness when sprayer 10 is subsequently activated to initiate spraying. For example, tube dampener 12 can retain the pressurized fluid at the end of a first spray event (e.g., when sprayer 10 is detriggered) and then such pressurized fluid is available downstream of pump 18 at the initiation of a second, subsequent spray event (e.g., when sprayer 10 is again triggered).

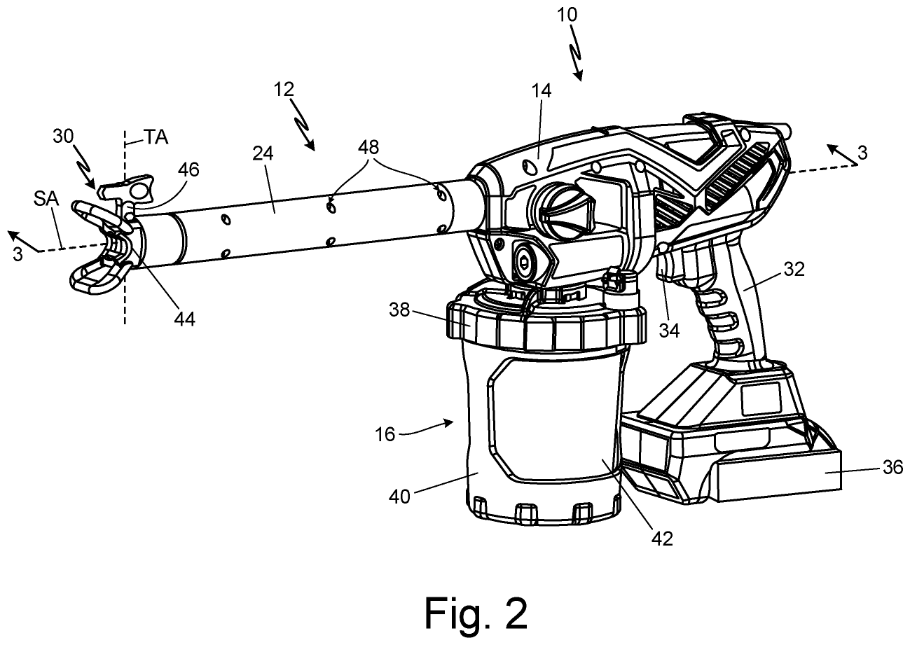

FIG. 2 is an isometric view of fluid sprayer 10 with tube dampener 12. Sprayer body 14, reservoir 16, tip assembly 30, handle 32, trigger 34, and power source 36 of sprayer 10 are shown. Reservoir 16 includes lid 38, cup 40, and liner 42. Tip assembly 30 includes tip housing 44 and spray tip 46. Dampener body 24 of tube dampener 12 is shown.

Sprayer 10 is a handheld sprayer configured to generate sprays of fluid that can be applied to a substrate. For example, sprayer 10 can be used for applying paint, varnishes, lacquer, finishes, stains, rust inhibitors, epoxy coatings, sealants, waterproofing, and other coatings that dry into a finish on the substrate. Paint will generally be used herein as an example, but it is understood that sprayer 10 can apply other coatings.

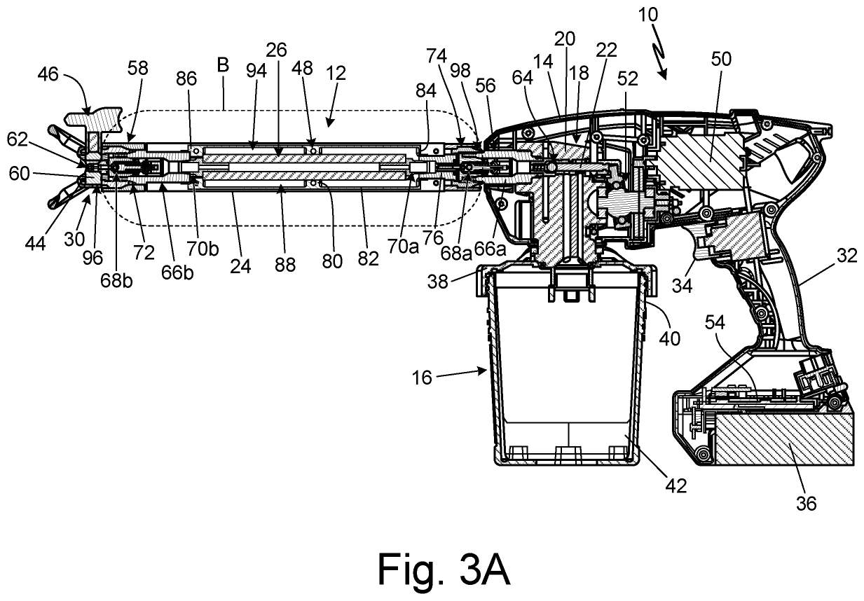

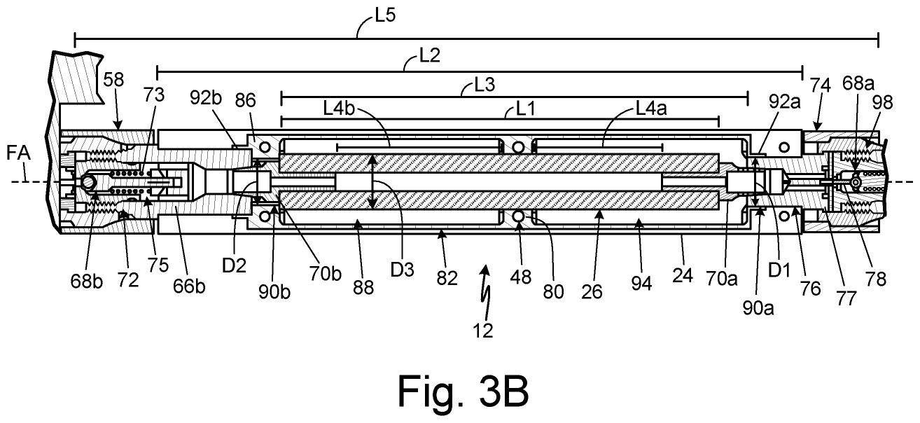

Sprayer body 14 contains components for causing spraying of spray fluid by sprayer 10. A pump, such as pump 18 (FIGS. 1 and 3), is disposed in sprayer body 14 to pump spray fluid from reservoir 16 to a nozzle of spray tip 46. Sprayer body 14 can be formed of any suitable material for supporting other components of sprayer 10. For example, sprayer body 14 can be formed from a polymer or metal. Sprayer body 14 can form a housing that can contain other components of sprayer 10. In some examples, sprayer body 14 is a clamshell housing formed from two halves with a seam along a lateral center of sprayer body 14.

Handle 32 projects from a lower side of sprayer body 14. A user can hold, support the full weight of, and operate sprayer 10 by grasping handle 32. Sprayer 10 is configured such that sprayer 10 can be operated by a single hand of the user. Sprayer 10 is configured to be entirely supportable by one hand of a user while spraying. Trigger 34 is located next to or formed as part of handle 32. In the example shown, trigger 34 extends from a front side of handle 32. Trigger 34 projects from handle 32 and towards reservoir 16, in the example shown. Actuating trigger 34 operates sprayer 10 to cause spraying by sprayer 10 and to stop spraying by sprayer 10. For example, the user can depress trigger 34 to activate spraying (e.g., by a switch of the trigger 34 powering a motor of the sprayer 10) and release trigger 34 to stop spraying.

Power source 36 provides power to sprayer 10 to cause spraying by sprayer 10. In the example shown, power source 36 is a removable battery. It is understood, however, that power source 36 can be formed by an electrical cord that can be plugged into a suitable outlet, such as a wall socket. Power source 36 provides power a motor disposed within sprayer body 14 to cause pumping by the pump of sprayer 10.

Reservoir 16 is configured to store a supply of spray fluid for spraying by sprayer 10. Lid 38 is attached to cup 40 and mounted to sprayer 10. Liner 42 is disposed within cup 40 and configured to hold the spray fluid. A lip of the liner 42 can be captured between cup 40 and lid 38 to form a fluid tight seal. Liner 42 can be accessed through windows formed in cup 40 to squeeze liner 42 and evacuate air from reservoir 16 during priming. Reservoir 16 is supported by sprayer body 14. In the example shown, reservoir 16 is fully supported by sprayer body 14. In some examples, reservoir 16 is mounted to sprayer body 14. In the example shown, reservoir 16 hangs below the sprayer body 14, though it is understood that in various other examples the reservoir 16 can be disposed above sprayer body 14 or otherwise integrated into sprayer body 14. While reservoir 16 is described as including cup 40, lid 38, and liner 42, it is understood that reservoir 16 can be formed in any desired manner suitable for storing a supply of spray fluid for spraying by sprayer 10.

In the example shown, reservoir 16 and handle 32 each project from the same side of sprayer body 14 (e.g., both handle 32 and reservoir 16 are disposed below a spray axis SA along which the fluid spray is emitted). It is understood that, in some examples, handle 32 and reservoir 16 can be disposed on different sides of sprayer body 14. In some examples, handle 32 and reservoir 16 can be disposed on opposite sides of sprayer body 14 (e.g., one of handle 32 and reservoir 16 can extend from a top side of sprayer body 14 and the other can extend from a bottom side of sprayer body 14).

Tube dampener 12 extends from and is supported by sprayer body 14. In some examples, tube dampener 12 is removably mounted to sprayer body 14. For example, tube dampener 12 can be connected to sprayer 10 by interfaced threading. In such an example, tube dampener 12 can be removed from sprayer body 14, such as by unthreading tube dampener 12 from a fitting disposed within or extending from sprayer body 14. In some examples, tube dampener 12 is integrated with and formed as an extension of sprayer body 14. In the example shown, dampener body 24 is elongate and extends from sprayer body 14. Dampener body 24 is cantilevered relative to sprayer body 14.

In the example shown, tube dampener 12 is elongate along the spray axis SA of sprayer 10. In the example shown, dampener body 24 is cylindrical, though it is understood that other examples are possible. Dampener body 24 is a rigid housing, which can be formed from a polymer or metal. In some examples, dampener body 24 is formed as a clamshell housing, such that dampener body 24 can be formed by multiple components fixed together. In the example shown, fasteners, such as bolts or screws, can extend through fastener openings 48 to fix a first clamshell portion and a second clamshell portion together to form the dampener body 24. Tube dampener 12 is cantilevered from sprayer body 14.

Tip assembly 30 is mounted to an end of tube dampener 12 opposite sprayer body 14. Tip assembly 30 is disposed at an end of dampener body 24 opposite the end of dampener body 24 connected to sprayer body 14. Tip assembly 30 is supported by the cantilevered tube dampener 12. Specifically, tip housing 44 is mounted to tube dampener 12 and supported by tube dampener 12. Spray tip 46 is mounted to and supported by tip housing 44. Spray tip 46 includes a nozzle configured to generate the fluid spray. The nozzle includes an orifice that can be shaped to form a desired spray pattern of the fluid spray. For example, the orifice can be a cat-eye shape. In the example shown, spray tip 46 is removable and can be replaced. In the example shown, spray tip 46 can be rotated about tip axis TA between a spray position and a de-clog position. The spray tip 46 is positioned to generate and eject an atomized fluid spray through nozzle when in the spray position. Spray tip 46 is reversed to eject any clogs or clumped fluid from spray tip 46 when in the de-clog position. Spray tip 46 can be reversed by rotating spray tip 46 180-degrees about the tip axis TA. Spray tip 46 can be configured to generate any desired spray pattern when in the spray position, such as a fan or cone, among other options.

Tube dampener 12 includes an internal flexible tube that routes the spray fluid under pressure from within the sprayer body 14 to the spray tip 46. The flexible tube is configured to flex in response to pressure pulses (i.e., pressure spikes) in the spray fluid being output by the pump disposed within the sprayer body 14. The flexible tube can function as an accumulator that expands in response to increases in pressure and contracts in response to decreases in pressure to maintain a consistent pressure at the nozzle, which pressure at the nozzle can be referred to as the spray pressure. Tube dampener 12 further provides an extension that allows the user to reach high points and reach around obstructions more easily for painting. The extension provided by tube dampener 12 provides for a more ergonomic and quicker spraying as the user can reach areas that previously requiring moving a ladder or other tool to facilitate reaching or requiring holding their arm in a more vertical position.

FIG. 3A is a cross-sectional view taken along line 3-3 in FIG. 2. FIG. 3B is an enlarged view of detail B in FIG. 3A. FIGS. 3A and 3B will be discussed together. Sprayer 10 and tube dampener 12 are shown. Sprayer 10 includes sprayer body 14, pump 18, reservoir 16, tip assembly 30, handle 32, trigger 34, power source 36, motor 50, drive 52, controller 54, and upstream valve 56. Reservoir 16 includes lid 38, cup 40, and liner 42. Tip assembly 30 includes tip housing 44, spray tip 46, and tip connector 58. Spray tip 46 includes barrel 60 and nozzle 62. Pump 18 includes pump body 20, fluid displacer 22, and pump valve 64. Upstream valve 56 includes valve housing 66a and valve member 68a. Tube dampener 12 includes dampener body 24; flexible tube 26; fittings 70a, 70b; downstream valve 72; sprayer connector 74; mount 76, and projection 78. Dampener body 24 includes inner support 80 and tube housing 82. Tube housing 82 includes upstream end 84 and downstream end 86 and defines interior chamber 88. Openings 90a, 90b respectively extend through upstream end 84 and downstream end 86. Locating extension 92a is formed on upstream end 84 and locating extension 92b is formed on downstream end 86. Downstream valve 72 includes valve housing 66b and valve member 68b.

Sprayer 10 is configured to generate and emit an atomized fluid spray for application on a substrate to apply a finish to that substrate. In the example shown, sprayer 10 is a handheld sprayer configured to be held, manipulated, and operated by a single hand of a user. Sprayer 10 includes a self-contained fluid supply that is stored within reservoir 16.

Pump 18, motor 50, and drive 52 are disposed at least partially within sprayer body 14. Motor 50 is an electric motor configured to generate a rotational output that powers reciprocation of the fluid displacer 22 of pump 18. Drive 52 is operatively connected to motor 50 to receive the rotational output from motor 50. Drive 52 is operatively connected to pump 18 to drive reciprocation of fluid displacer 22. For example, drive 52 can be configured as a wobble drive, among other options.

Controller 54 is operatively connected to motor 50, electrically and/or communicatively, to control operation of the motor 50. Controller 54 is configured to receive an actuation signal based on actuation of trigger 34. Upon receiving the actuation signal, controller 54 directs power from power supply 36 to the motor 50 that causes the motor 50 to output the rotational motion. The rotational motion is converted by drive 52 to reciprocating linear motion that is input to pump 18 to power pumping by pump 18.

Pump body 20 is at least partially disposed within sprayer body 14 and is supported by sprayer body 14. Fluid displacer 22 is configured to reciprocate along an axis to pump the spray fluid downstream through tube dampener 12 and through spray tip 46 to generate the fluid spray. Pump valve 64 is a check valve disposed downstream of fluid displacer 22 and within pump body 20. Pump valve 64 prevents retrograde flow during a suction stroke of fluid displacer 22. In the example shown, fluid displacer 22 is formed as a piston that is configured to reciprocate along a reciprocation axis. It is understood that, while a single fluid displacer 22 is shown, pump 18 can include multiple fluid displacers 22. For example, pump 18 can include three pistons that reciprocate out of phase with respect to each other. Further, while fluid displacer 22 is shown as a piston, it is understood that fluid displacer 22 can be configured as a diaphragm that reciprocates to pump the spray fluid. The pump 18 draws fluid from the fluid reservoir 16 and puts the fluid under pressure, outputting the fluid through the tube dampener 12 to the nozzle 62. The nozzle 62 outputs the fluid as an atomized spray, such as a spray fan, among other spray pattern options.

Reservoir 16 stores the supply of spray fluid that is pumped by pump 18. In the example shown, the spray fluid is stored in the liner 42 of reservoir 16, which is disposed within cup 40 and at least partially captured between cup 40 and lid 38. Lid 38 is connected to other components of sprayer 10 to secure reservoir 16 to sprayer 10. Cup 40 includes windows through which the liner 42 can be accessed to squeeze air out of the liner 42 and assist in priming pump 18. In the example shown, lid 38 is directly connected to a portion of pump body 20 to secure reservoir 16 to sprayer 10.

The example shown does not include any accumulator between reservoir 16 and pump 18. Instead, the spray fluid is drawn directly from reservoir 16 and into the rigid passages within pump body 20. Sprayer 10 does not include flexible tubing or otherwise resilient flow passages upstream of pump 18. Sprayer 10 does not include an accumulator disposed upstream of pump body 20. Sprayer 10 does not include an accumulator disposed upstream of the flowpaths within sprayer body 14.

Upstream valve 56 is directly connected to pump body 20. The valve housing 66a of upstream valve 56 interfaces with and is connected to pump body 20, in the example shown. For example, valve housing 66a can be connected to pump body 20 by interfaced threading. Valve member 68a is disposed within the valve housing 66a and is actuatable between a closed state, preventing flow through upstream valve 56, and an open state, allowing flow downstream through upstream valve 56. Upstream valve 56 can be configured as a pressure-actuated valve, among other options. For example, upstream valve 56 can shift from the closed state to the open state based on the pressure in valve housing 66a reaching a predetermined pressure threshold, the pressure causing the valve member 68a to shift to the open state. It is understood that, while sprayer 10 is described as including upstream valve 56, not all examples are so limited. Some examples of sprayer 10 do not include an upstream valve 56 such that the spray fluid can freely flow downstream from pump body 20 and into tube dampener 12. Upstream valve 56 is disposed downstream of pump 18 and upstream of tube dampener 12.

Tube dampener 12 projects outward from sprayer body 14. Dampener body 24 is elongate along a flow axis FA through tube dampener 12. In the example shown, flow axis FA is disposed coaxially with spray axis SA. In the example shown, dampener body 24 is cylindrical and defines a cylindrical interior chamber 88. Interior chamber 88 is formed within the dampener body 24. Specifically, interior chamber 88 is formed within tube housing 82 of dampener body 24. In the example shown, tube housing 82 extends for less than the full length of dampener body 24, though it is understood that not all examples are so limited. For example, the tube housing 82 can extend up to a full length of the dampener body 24. The dampener body 24 can be a rigid tube. The dampener body 24 can be formed from metal and/or polymer. The dampener body 24 provides most or all of the structural support of the tube dampener 12, including to the nozzle 62. Tube dampener 12 is configured such that tube dampener does not flex or otherwise deform relative to the flow axis FA. The tube dampener 12 is rigidly connected to sprayer 10 regardless of whether the connection is removable or not.

Flexible tube 26 is disposed within dampener body 24. Flexible tube 26 does not provide structural support but is instead supported by dampener body 24 and other components of tube dampener 12. More specifically, flexible tube 26 is disposed in the tube housing 82 of dampener body 24. Flexible tube 26 is disposed within a portion of dampener body 24 defined by tube housing 82. The length L1 of flexible tube 26 is less than the length L2 of dampener body 24. The length L1 is less than the length L3 of the interior chamber 88 within tube housing 82. It is understood, however, that length L1 can be up to the length L3 of the interior chamber 88. In the example shown, the length L2 of dampener body 24 is less than the length L5 of tube dampener 12. In some examples, dampener body 24 can be at least about 6 inches (in.) (about 15.24 centimeters (cm)) in length. In some examples, dampener body 24 can be at least about 10 in. (about 25.4 cm) in length. In some examples, dampener body 24 can be at least about 12 in. (about 30.48 cm) in length. In some examples, tube dampener 12 can be at least about 6 inches (in.) (about 15.24 centimeters (cm)) in length. In some examples, tube dampener 12 can be at least about 10 in. (about 25.4 cm) in length. In some examples, tube dampener 12 can be at least about 12 in. (about 30.48 cm) in length. In some examples, tube dampener 12 can be greater than about 12 feet (about 3.66 meters) in length. In the example shown, the length L5 of the tube dampener 12 is between the end of sprayer connector 74 and the end of downstream valve 72.

To counteract pressure variations, the unsupported length of flexible tube 26 is at least about 2 in. (about 5.08 cm). In the example shown, the unsupported length of flexible tube 26 is a combination of the length L4a between the end of fitting 70a within flexible tube 26 and inner support 80 and the length L4b between the inner support 80 and the end of fitting 70b within flexible tube 26. In some examples, the unsupported length of flexible tube 26 is at least about 3 in. (about 7.62 cm), at least about 4 in. (about 10.16 cm), at least about 5 in. (about 12.7 cm), at least about 10 in. (about 25.4 cm), at least about 12 in. (about 30.48 cm), among other options. In some examples, the unsupported length of the hose is up to about 12 feet (about 3.66 meters) in length. A ratio of the unsupported length of flexible tube 26 to the length of dampener body 24 can be at least 1:2, 1:3, 1:4, or another ratio. In some examples, the unsupported length of flexible tube 26 can be at least 50% of the length of the interior chamber 88. In some examples, the unsupported length of the flexible tube 26 can be at least 60% of the length of interior chamber 88. In some examples, the unsupported length of the flexible tube 26 can be at least about 70% of the length of the interior chamber 88, at least about 80% of the length of the interior chamber 88, at least about 90% of the length of the interior chamber, among other options.

Flexible tube 26 is configured to deform in response to pressure fluctuations in the flow of spray fluid output by pump 18. Flexible tube 26 is formed from a deformable material to flex in response to those pressure variations, such as by expanding due to increases in pressure (e.g., pressure spikes) and returning to an unflexed state from the expanded state due to decreases in pressure (e.g., pressure dips). For example, flexible tube 26 can be formed from a polymer. For example, flexible tube 26 can be formed from rubber, low durometer polyvinyl chloride (PVC), etc. Flexible tube 26 is formed from a resilient material that returns to an unflexed state after flexing in response to the pressure spikes. Flexible tube 26 can including braiding to reinforce the resilient material forming the flexible tube 26 and prevent over-accumulation within flexible tube 26. Flexible tube 26 can be formed from an elastic material that is reinforced with a high tensile strength material. Flexible tube 26 can be formed from an elastomer reinforced with a braided layer.

The function of the flexible tube 26 is to expand within the interior chamber 88 during pressure pulses (i.e. pressure spikes) created by the reciprocation of the fluid displacer(s) 22 of the pump 18, which may otherwise cause an uneven spray pattern. The flexible tube 26 resiliently expands upon pressure spikes to decrease downstream pressure at the nozzle 62 and contracts upon cessation of the pressure spike to keep output pressure at the nozzle 62 steady throughout the cycles of the pump 18, fostering a consistent spray pattern. The flexible tube 26 is fully contained within the dampener body 24, and is not exposed. In the example shown, the flexible tube 26 is fully contained within the tube housing 82 and not exposed outside of the tube housing 82. The flexible tube 26 is not a structural part except for holding the spray fluid under pressure. The flexible tube 26 is kept straight within the tube dampener 12 and extends along a flow axis FA, which is coaxial with the spray axis SA in the example shown.

Flexible tube 26 is disposed coaxially with dampener body 24 in the example shown. Specifically, flexible tube 26 is formed as a cylindrical tube that has a cylindrical interior, and flexible tube 26 is disposed coaxially with the cylindrical interior chamber 88. A gap 94 is disposed circumferentially about flexible tube 26. The gap 94 is cylindrical in the example shown. The gap 94 is formed between an exterior radial surface of the flexible tube 26 and the interior radial surface of the tube housing 82. The gap 94 is radially outside of the flexible tube 26 and radially inside of the tube housing 82.

Inner support 80 extends radially inward and into interior chamber 88. Inner support 80 can be formed by one or more projections that extend into interior chamber 88. In some examples, inner support 80 can be formed as a ring that surrounds flexible tube 26. For example, the inner support 80 can be an inwardly projecting ring which annularly engages an exterior of the flexible tube 26. In the example shown, inner support 80 interfaces with an exterior of flexible tube 26. In the example shown, flexible tube 26 is formed as having multiple unsupported segments that together form the unsupported length of flexible tube 26.

Inner support 80 supports a span of the flexible tube 26, such as to reduce sagging and/or swaying of the flexible tube 26 within the interior chamber 88. As such, flexible tube 26 can be supported at one or more locations between the axial ends of flexible tube 26. In the example shown, one of fastener openings 48 extends through inner support 80 to facilitate connecting the two halves of the clamshell configuration of dampener body 24.

Tube housing 82 extends axially between upstream end 84 and downstream end 86. Upstream end 84 is formed by a wall extending radially inward relative to the exterior of dampener body 24. Downstream end 86 is formed by a wall extending radially inward relative to the exterior of dampener body 24. Opening 90a is formed through the wall of upstream end 84 and opening 90b is formed through the wall of downstream end 86. In the example shown, opening 90a has a diameter D1, openings 90b has a diameter D2, and flexible tube 26 includes an outer diameter D3. In the example shown, outer diameter D3 is larger than diameters D1, D2 such that flexible tube 26 is prevented from freely passing out of interior chamber 88 through openings 90a, 90b. Locating extension 92a extends axially from a side of upstream end 84 opposite interior chamber 88. Locating extension 92a can be formed as a ring about the flow axis FA, among other options. Locating extension 92b extends axially from a side of downstream end 86 opposite interior chamber 88. Locating extension 92b can be formed as a ring about the flow axis FA, among other options. Locating extension 92a extends in an opposite axial direction from locating extension 92b.

Upstream end 84 and downstream end 86 axially define the interior chamber 88 within tube housing 82. In the example shown, interior chamber 88 can be considered to be formed by multiple sub-chambers within tube housing 82. The first sub-chamber is formed axially between upstream end 84 and inner support 80 and the second sub-chamber is formed axially between downstream end 86 and inner support 80. It is understood that interior chamber 88 can be formed by one or more sub-chambers, including more than two sub-chambers.

Fittings 70a, 70b interface with flexible tube 26. As such, flexible tube 26 can be considered to be mounted on fittings 70a, 70b. Fitting 70a, 70b support flexible tube 26 within the interior chamber 88. In the example shown, fittings 70a, 70b do not directly interface with dampener body 24. Instead, the fittings 70a, 70b are supported relative to the dampener body 24 by connection with downstream valve 72 and mount 76.

Fitting 70a is disposed at an upstream end of flexible tube 26 and fitting 70b is disposed at a downstream end of flexible tube 26. In the example shown, fitting 70a extends into opening 90a through upstream end 84. Fitting 70a is connected to mount 76 at the upstream end of flexible tube 26. For example, fitting 70a can be connected to mount 76 by interfaced threading therebetween. In the example shown, fitting 70b extends into opening 90b through downstream end 86. Fitting 70b is connected to valve housing 66b at the downstream end of flexible tube 26. For example, fitting 70b can be connected to valve housing 66b by interfaced threading therebetween.

In the example shown, each fitting 70a, 70b includes a projection that extends into the flexible tube 26. The fittings 70a, 70b are inserted into opposite ends of the flexible tube 26, which may slightly expand the ends of the flexible tube 26 to create an interference fit that seals an internal passage between the pump 18 and the nozzle 62. For example, one or both of fittings 70a, 70b can include a barbed projection that extends into flexible tube 26. Fittings 70a, 70b can include threaded portions on the opposite axial side of each fitting 70a, 70b from the projections that extend into flexible tube 26.

Downstream valve 72 is disposed downstream of flexible tube 26. In the example shown, downstream valve 72 does not directly interface with flexible tube 26. Instead, fitting 70b is disposed between and connected flexible tube 26 and downstream valve 72. Specifically, fitting 70b is connected to valve housing 66b of downstream valve 72. For example, fitting 70b can be connected to valve housing 66b by interfaced threading between fitting 70b and valve housing 66b.

Downstream valve 72 is at least partially disposed within dampener body 24. In the example shown, at least a portion of valve housing 66b is disposed within tube housing 82. In the example shown, downstream valve 72 does not extend into interior chamber 88, though it is understood that not all examples are so limited. A portion of valve housing 66b interfaces with locating extension 92b of tube housing 82. The locating extension 92b interfacing with valve housing 66b aligns downstream valve 72 with tube housing 82 and thus with fitting 70b and flexible tube 26 on flow axis FA. The interface between locating extension 92b and valve housing 66b can prevent downstream valve 72 from pivoting relative to flow axis FA and relative to flexible tube 26 and fitting 70b. In some examples, locating extension 92b and valve housing 66b can be contoured to prevent rotation of downstream valve 72b and tube housing 82 relative to each other. For example, the inner radial surface of locating extension 92b can be non-circular (e.g., polygonal, oval, etc.) and the exterior surface of at least the portion of valve housing 66b interfacing with locating extension 92b can be similarly contoured to mate with that non-circular surface of locating extension 92b.

Downstream valve 72 is disposed to receive the spray fluid output from flexible tube 26. Valve member 68b is disposed at least partially within valve housing 66b. Valve member 68b is actuatable between a closed state, preventing flow through downstream valve 72, and an open state, allowing flow downstream through downstream valve 72. Downstream valve 72 can be configured as a pressure-actuated valve, among other options. For example, downstream valve 72 can shift from the closed state to the open state based on the pressure in the chamber 75 within valve housing 66b reaching a predetermined pressure threshold that overcomes the force exerted on valve member 68b by spring 73. The fluid pressure in chamber 75 causes the valve member 68b to shift to the open state. The pressure overcoming the spring force of spring 73 and causing downstream valve 72 to shift to the open state only occurs while motor 50 is operating, which occurs when trigger 34 is activated. As shown, the downstream valve 72 includes a needle and seat sealing interface, though it is understood that other configurations are possible.

It is noted that the downstream valve 72 is not directly actuated by trigger 34 (e.g., no mechanical link such that actuation of the trigger 34 mechanically opens the downstream valve 72). Rather, the downstream valve 72 is opened indirectly by actuation of the trigger 34 which sends an electrical signal which activates the controller 54 to power the motor 50 which operates the drive 52 to operate the pump 18 to move fluid from the fluid reservoir 16 through the tube dampener 12, including through the flexible tube 26 and into the chamber 75 to increase pressure within the chamber 75 to overcome the spring 73 to open the downstream valve 72 to release the fluid from the chamber 75 as a spray through the nozzle 62. Release of the trigger 34 causes the motor 50 to stop which causes decrease in fluid pressure and consequently closure of downstream valve 72 which stops spaying of the fluid.

Downstream valve 72 forms the restriction (e.g., restriction 28 (FIG. 1)) of the tube dampener 12. While tube dampener 12 is shown as including a restriction formed by a pressure-actuated valve, it is understood that tube dampener 12 can include any desired restriction for preventing free flow of spray fluid out of tube dampener 12 and for facilitating pressure accumulation in flexible tube 26. In some examples, downstream valve 72 can be configured as a manually activated valve, such as a valve that the user can actuate between open and closed states such as by manipulating a valve member. In some examples, the restriction is formed by a constriction, such as a small diameter orifice, disposed downstream of flexible tube 26.

Tip assembly 30 is mounted to and supported by tube dampener 12. In the example shown, tip assembly 30 is directly mounted to valve housing 66b. Specifically, tip assembly 30 is mounted to valve housing 66b by interfaced threading formed therebetween. More specially, tip housing 44 is mounted to valve housing 66b by tip connector 58. Tip connector 58 is rotatable about a portion of tip housing 44 and can be rotated to form and break the threaded interface between tip assembly 30 and valve housing 66b. Tip bore 96 is formed in tip housing 44. Spray tip 46 is at least partially disposed within tip bore 96. Specifically, barrel 60 of spray tip 46 is disposed within tip bore 96. In the example shown, spray tip 46 is rotatable between a spray position (shown in FIG. 3) and a de-clog position in which spray tip 46 is rotated 180-degrees on tip axis TA relative to the spray position. Nozzle 62 is supported by and at least partially disposed within barrel 60 of spray tip 46.

Mount 76 is disposed upstream from flexible tube 26. In the example shown, mount 76 does not directly interface with flexible tube 26. Instead, fitting 70a is disposed between and connects flexible tube 26 and mount 76. A first end of mount 76 is connected to fitting 70a and a second end of mount 76, opposite the first end, is disposed adjacent upstream valve 56. The first end of mount 76 connected to fitting 70a interfaces with dampener body 24. Specifically, the first end of mount 76 interfaces with upstream end 84 of tube housing 82.

Mount 76 projects axially outward from tube housing 82 of dampener body 24. Mount 76 is at least partially disposed within dampener body 24. A portion of mount 76 interfaces with locating extension 92a of tube housing 82. The locating extension 92a interfacing with mount 76 aligns mount 76 with tube housing 82 and thus with fitting 70a and flexible tube 26. The interface between locating extension 92a and mount 76 can prevent mount 76 from pivoting relative to flow axis FA and relative to flexible tube 26 and fitting 70a. In some examples, locating extension 92a and mount 76 can be contoured to prevent rotation of mount 76 and tube housing 82 relative to each other. For example, the inner radial surface of locating extension 92a can be non-circular (e.g., polygonal, oval, etc.) and the exterior surface of mount 76 can be similarly contoured to mate with that non-circular surface of locating extension 92a.

Mount 76 interfaces with sprayer 10 at an upstream end of mount 76 to receive fluid output from sprayer 10. In the example shown, mount 76 interfaces with a downstream end of upstream valve 56. Projection 78 extends axially from mount 76. Projection 78 extends through the outlet of upstream valve 56 and interfaces with valve member 68a. Projection 78 extends axially through the seat of the upstream valve 56.

Projection 78 pushes valve member 68a away from a seat of upstream valve 56 such that upstream valve 56 is in the open state with tube dampener 12 mounted to sprayer 10. Projection 78 is disposed coaxial with the flow axis FA in the example shown. In the example shown, projection 78 is formed as a pin that interfaces with valve member 68a. In the example shown, tube dampener 12 is configured such that only a single valve downstream of pump 18 actively controls the flow of spray fluid to nozzle 62. Maintaining upstream valve 56 in the open state with tube dampener 12 mounted to sprayer 10 provides quick reaction when spraying is initiated. In the example shown, the pressure output by pump 18 needs to open only one valve (downstream valve 72 in the example shown) rather than opening multiple valves in sequence.

Tube dampener 12 is connected to sprayer 10 at interface 98. In the example shown, tube dampener 12 is connected to valve housing 66a of upstream valve 56 at interface 98. Specifically, sprayer connector 74 of tube dampener 12 interfaces with a portion of valve housing 66a projecting out of sprayer body 14 at interface 98, in the example shown. Sprayer connector 74 is supported by dampener body 24. Specifically, sprayer connector 74 is disposed on mount 76 that is interfaces with dampener body 24. In the example shown, sprayer connector 74 interfaces with a flange 77 of mount 76 to axially retain sprayer connector 74 on mount 76. Sprayer connector 74 can be disposed on mount 76 such that sprayer connector is freely rotatable about mount 76. In the example shown, interface 98 is formed as a threaded connection. Sprayer connector 74 includes threads configured to interface with threads formed on the exterior of valve housing 66a to form the interface 98 between dampener body 24 and sprayer 10. Interface 98 being formed as a threaded interface facilitates connecting and disconnecting tube dampener 12 from sprayer 10. It is understood that, while interface 98 is shown as a threaded interface, interface 98 can be of any desired configuration, such as a bayonet-type connection, quick connect with a movable sleeve, etc.

In the example shown, the sprayer connector 74 can be configured similar to tip connector 58, such that either one of tip connector 58 and sprayer connector 74 can mounted to sprayer at the same interface 98. Such a configuration facilitates a modular configuration of sprayer 10. For example, tip assembly 30 can be disconnected from sprayer 10, tube dampener 12 can be mounted to sprayer 10 by interfacing sprayer connector 74 with sprayer 10, and tip assembly 30 can be mounted to tube dampener 12. In the example shown, tip assembly 30 can be disconnected from sprayer 10 by unthreading tip connector 58 from valve housing 66a, tube dampener 12 is connected to sprayer 10 by threading sprayer connector 74 onto valve housing 66a, and tip assembly 30 is connected to tube dampener 12 by threading tip connector 58 onto valve housing 66b.

While interface 98 is described as a connectable and disconnectable interface, it is understood that in some examples tube dampener 12 can be mounted to sprayer 10 at a permanent interface. The permanent connection can be formed by tube dampener 12 being formed separately from sprayer 10 and connected to sprayer 10 in a manner not intended to be disconnected from sprayer 10 by a user.

Tube dampener 12 dampens pulsation in the spray fluid downstream from pump 18 and prior to the spray fluid being emitted from nozzle 62. Tube dampener 12 is disposed fully downstream of the pump 18, not within the pump 18. The dampener body 24 does not contain any components that are actively moving during spraying. The valve member 68b of downstream valve 72 does shift to the open state but remains in the open state throughout spraying, the valve member 68b does not reciprocate or otherwise continue to move throughout spraying. No active pumping member is disposed within the dampener body 24. Fluid displacer 22 does not extend into or reciprocate within the dampener body 24.

Dampener body 24 is formed separately from pump body 20. In the example shown, dampener body 24 does not directly interface with the spray fluid as the spray fluid is pumped downstream through tube dampener 12. Instead, the spray fluid is fully contained within other components of tube dampener 12. Dampener body 24 providers structural support to other components of tube dampener 12 and does not directly contain the fluid pressure. Flexible tube 26 does not provide structural support and does directly contain the fluid pressure. The flexible tube 26 is disposed fully within dampener body 24. Flexible tube 26 does not extend into the pump body 20. No portion of the flexible tube 26 is disposed within the pump body 20 in the example shown. The flexible tube 26 is isolated from the pump 18 and downstream from the pump 18. In the example shown, flexible tube 26 does not extend into sprayer body 14. No portion of flexible tube 26 extends into sprayer body 14.

Tube dampener 12 provides significant advantages. Flexible tube 26 is nonstructural except to support the fluid pressure of the spray fluid output from pump 18. Flexible tube 26 dampens pressure fluctuations output from pump 18 to provide a steady pressure at nozzle 62 such that sprayer 10 outputs the fluid spray as a consistent spray pattern. The consistent spray pattern provides an even finish on the substrate during spraying. The consistent spray pattern further provides an aesthetically appealing finish on the substrate. Tube dampener 12 projects from sprayer body 14 such that tube dampener 12 provides an extension of sprayer 10. Tube dampener 12 thus makes it easier for the user to reach and apply finishes at high and low locations, providing for easier and more efficient spraying.

Although the present invention has been described with reference to preferred embodiments, workers skilled in the art will recognize that changes may be made in form and detail without departing from the spirit and scope of the invention.

1. A tube dampener for use in a portable fluid sprayer, the tube dampener comprising:
a dampener body elongate along a flow axis and having an interior space;
a flexible tube disposed within the interior space such that a gap is disposed circumferentially around the flexible tube and radially between the flexible tube and the dampener body, the flexible tube formed such that the flexible tube can flex in response to pressure pulsations of spray fluid flowing through the flexible tube; and
a restriction disposed downstream of the flexible tube to inhibit free flow of the spray fluid out of the flexible tube.

2. The tube dampener of claim 1, further comprising:
a first fitting mounted to an upstream end of the flexible tube and supporting the flexible tube within the interior space; and
a second fitting mounted to a downstream end of the flexible tube and supporting the flexible tube within the interior space.

3. The tube dampener of claim 2, wherein:
the restriction comprises a valve disposed downstream of the flexible tube, the valve connected to the second fitting; and
a mount is disposed upstream of the flexible tube and connected to the first fitting.

4. The tube dampener of claim 3, wherein:
a valve housing of the valve is threadedly connected to the second fitting; and
the mount is threadedly connected to the first fitting.

5. The tube dampener of claim 1, further comprising:
a connector supported by the dampener body, the connector rotatable about the flow axis and including interior threads, the connector configured to connect the tube housing to the portable fluid sprayer.

6. The tube dampener of claim 5, further comprising:
a mount disposed upstream of the flexible tube and connected to the first fitting, wherein the connector is disposed on the mount.

7. The tube dampener of claim 1, wherein the mount includes a first mount end connected to the first fitting and a second mount end opposite the first mount end, and wherein the first mount end interfaces with the dampener body.

8. The tube dampener of claim 7, wherein the dampener body includes a tube housing defining the interior space, the flexible tube fully disposed within the tube housing, and wherein the first mount end extends into a locating extension projecting from an upstream end of the tube housing.

9. The tube dampener of claim 7, further comprising:
a projection extending from the mount and away from the first fitting, the projection extending beyond the second mount end.

10. The tube dampener of claim 9, wherein the projection is formed as a pin disposed coaxial with the flow axis.

11. The tube dampener of claim 1, wherein the restriction comprises a valve.

12. The tube dampener of claim 11, wherein the valve is a pressure actuated valve configured to be opened by a fluid pressure from the flexible tube.

13. The tube dampener of claim 12, wherein the valve includes a valve housing, a valve member disposed within the valve housing, and a spring interfacing with the valve member to bias the valve member towards a closed state.

14. The tube dampener of claim 13, wherein the dampener body includes a tube housing defining the interior space, the flexible tube fully disposed within the tube housing, and wherein the valve housing extends into a locating extension projecting from a downstream end of the tube housing.

15. The tube dampener of claim 1, further comprising:
an inner support that extends into the interior space and interfaces with an exterior of the flexible tube to support a span of the flexible tube.

16. The tube dampener of claim 15, wherein the inner support is formed by the dampener body.

17. The tube dampener of claim 1, wherein the flexible tube has a first length, the dampener body has a second length, the first length is less than the second length, and the first length is at least half of the second length.

18. The tube dampener of claim 1, wherein the flexible tube includes a resilient material and a braided enforcement layer.

19. The tube dampener of claim 1, further comprising:
a tip assembly mounted at a downstream end of the dampener body, the tip assembly including a spray tip rotatable between a first position for spraying and a second position for unclogging.

20. (canceled)

21. A portable fluid sprayer comprising:
a sprayer body;
a pump disposed within the sprayer body;
a tube dampener disposed downstream from the pump and that receives spray fluid output from the pump, the tube dampener comprising:
a dampener body elongate along a flow axis, the dampener body defining an interior space; and
a flexible tube disposed within the interior space, the flexible tube configured to dampen pulsation of the spray fluid output from the pump and traveling through the flexible tube; and
a nozzle disposed downstream from the flexible tube, the nozzle configured to receive the spray fluid output from the flexible tube and generate a spray of the spray fluid.

22.-52. (canceled)
